(19) United States
(12) Patent Application Publication
(10) Pub. No.: US 2014/0118704 A1
(43) Pub. Date: May 1, 2014

(54) Mobile Device, Case and Attachment with Retractable Optic

(71) Applicant: MICROVISION, INC., Redmond, WA (US)

(72) Inventors: Markus Duelli, Seattle, WA (US); P. Selvan Viswanathan, Bellevue, WA (US); Joshua O. Miller, Woodinville, WA (US); James A. Yasukawa, Tracy, CA (US)

(73) Assignee: MICROVISION, INC., Redmond, WA (US)

(21) Appl. No.: 13/665,240

(22) Filed: Oct. 31, 2012

(51) Int. Cl. G03B 21/14

(52) U.S. Cl. 353/70; 353/119

(57) ABSTRACT

A retractable optic conditionally redirects an image from a scanning laser projector. The retractable optic may be coupled to a mobile device, a mobile device case, or may be part of an attachment. The retractable optic includes a reflective surface that has a free-form shape defined by a polynomial that is a function of two independent, transverse coordinate variables.

### FIELD

The present invention relates generally to scanning laser projectors, and more specifically to short throw scanning laser projectors.

### BACKGROUND

A projector's “throw ratio” is defined as the distance from the projector to the projection surface divided by the width of the projected image. “Short throw” projectors have a relatively small throw ratio, so a large image can be projected for any given projection distance. “Ultra-short throw” projectors have an even smaller throw ratio, so an even larger image can be projected for any given projection distance. Ultra-short throw projectors are typically used in fixed installations and use a combination of reflective and refractive optics.

### BRIEF DESCRIPTION OF THE DRAWINGS

FIG. 1 shows a mobile device with a scanning laser projector and retractable optic in a retracted position in accordance with various embodiments of the present invention;

FIG. 2 shows a partial side view of the mobile device of FIG. 1;

FIG. 3 shows the mobile device of FIG. 1 projecting an image with the optic retracted;

FIG. 4 shows a mobile device with a scanning laser projector and retractable optic in a deployed position in accordance with various embodiments of the present invention;

FIG. 5 shows a partial side view of the mobile device of FIG. 4;

FIG. 6 shows the mobile device of FIG. 4 projecting an image with the optic deployed;

FIG. 7 shows a surface map of a free-form optic in accordance with various embodiments of the present invention;

FIG. 8 shows front, top, and side views of a mobile device with a retractable optic in various positions in accordance with various embodiments of the present invention;

FIG. 9 shows a mobile device with a scanning laser projector and retractable optic in a retracted position in accordance with various embodiments of the present invention;

FIG. 10 shows the mobile device of FIG. 9 projecting an image with the optic retracted;

FIG. 11 shows a mobile device with a scanning laser projector and retractable optic in a deployed position in accordance with various embodiments of the present invention;

FIG. 12 shows the mobile device of FIG. 9 projecting an image with the optic deployed;

FIG. 13 shows a mobile device with a scanning laser projector, a retractable optic, and an articulating joint in accordance with various embodiments of the present invention;

FIG. 14 shows a side view of the mobile device of FIG. 13 with the optic deployed;

FIG. 15 shows a mobile device with a retractable optic in a retracted position in accordance with various embodiments of the present invention;

FIG. 16 shows the mobile device of FIG. 15 with the retractable optic in a deployed position in accordance with various embodiments of the present invention;

FIG. 17 shows a mobile device case with a kickstand and retractable optic in retracted positions in accordance with various embodiments of the present invention;

FIG. 18 shows the mobile device case of FIG. 17 with the kickstand and retractable optic in deployed positions in accordance with various embodiments of the present invention;

FIG. 19 shows a mobile device with a retractable optic attachment in a deployed position in accordance with various embodiments of the present invention;

FIG. 20 shows a mobile device with a retractable optic attachment in a retracted position in accordance with various embodiments of the present invention;

FIG. 21 shows a block diagram of a scanning laser projector in accordance with various embodiments of the present invention; and

FIGS. 22 and 23 show users interacting with a scanning laser projector in a mobile device.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

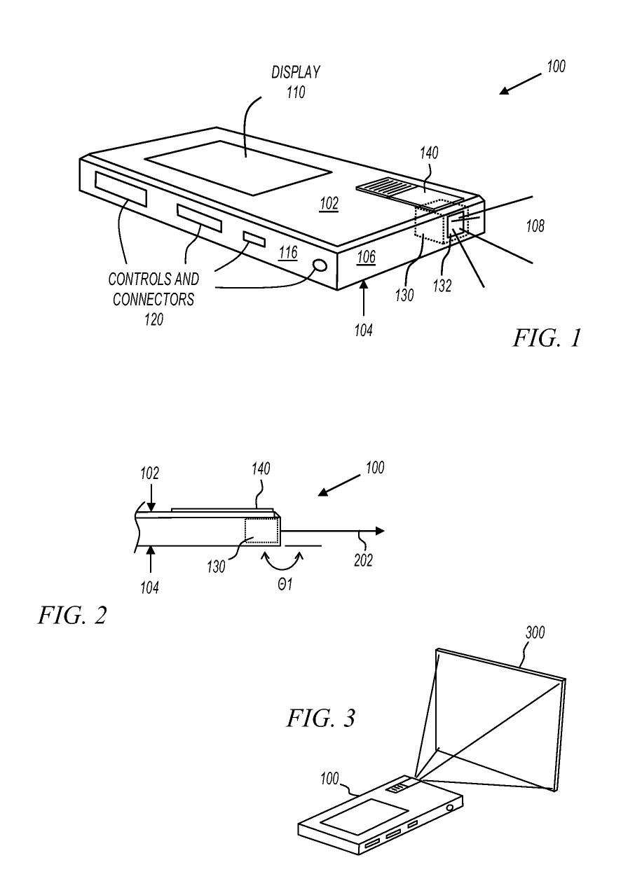

FIG. 1 shows a mobile device with a scanning laser projector and retractable optic in a retracted position in accordance with various embodiments of the present invention. Mobile device 100 includes display 110, controls and connectors 120, retractable optic 140, and scanning laser projector 130. Mobile device 100 also includes a housing having opposing first and second major faces 102, 104, and first and second sides 106, 116 connecting the first and second major faces. Major face 102 is referred to as the first major face, and major face 104 is referred to as the second major face, although this is not a limitation of the present invention. The terms “first” and “second” are used only as labels, and are not meant to be used in a limiting sense. For example, major face 104 may be referred to as the first major face and major face 102 may be referred to as the second major face without departing from the scope of the present invention.

As shown in FIG. 1, the first and second major faces are substantially parallel, although this is not a limitation of the present invention. As used herein, the term “substantially parallel” refers to the two major faces being close enough to parallel that a user holding the mobile device would perceive the two major faces as being opposite sides of the device. For example, the two major faces may have a small angular offset relative to each other and still be considered substantially parallel. Similarly, sides 106 and 116 is shown at a substantially 90 degree angle relative to the first and second major faces. This is also not a limitation of the present invention. Sides 106 and 116 may be at any angle relative to one major face or the other without departing from the scope of the present invention.

Side 106 is referred to herein as a “short side” and side 116 is referred to herein as a “long side.” The terms “short side” and “long side” are used as labels to differentiate between sides of mobile device 100 based on their length.

Scanning laser projector 130 may be used to project an image from projector port 132 on side 106 into a fixed field of view 108. Scanning laser projector 130 may include laser light sources and a microelectromechanical (MEMS) scanning mirror to reflect the laser light in a raster pattern. Scanning laser projector 130 may also include electronics to control pixel generation and MEMS scanning mirror movement.

Retractable optic 140 is movably coupled to the housing such that when retracted, the retractable optic 140 is stowed on one of the first and second major faces. In the example of FIG. 1, retractable optic 140 is stowed in a retracted position on the first major face 102. When retractable optic 140 is retracted, the image produced by projector 130 is projected into the fixed field of view 108 without being redirected by optic 140. Retractable optic 140 may be deployed such that it redirects the image. Examples of deployed retractable optics are described further below. In some embodiments, retractable optic 140 is a reflective optical device with a non-flat surface. Retractable optics with non-flat reflective surfaces are described further below with reference to FIG. 7.

Mobile device 100 may be a hand held projection device with or without communications ability. For example, in some embodiments, mobile device 100 may be a handheld accessory projection apparatus with little or no other capabilities. Also for example, in some embodiments, mobile device 100 may be a device usable for communications, including for example, a cellular phone, a smart phone, a personal digital assistant (PDA), a global positioning system (GPS) receiver, or the like. Further, mobile device 100 may be connected to a larger network via a wireless (e.g., WiMax) or cellular connection, or this device can accept and/or transmit data messages or video content via an unregulated spectrum (e.g., WiFi) connection.

Mobile device 100 may also be a hand held interactive projection device. For example, in some embodiments, a user may interact with projected content by gesturing within the fixed field of view 108. Interactive embodiments are described further below.

Display 110 may be any type of display. For example, in some embodiments, display 110 includes a touch sensitive display device that functions as both an input device and an output device. Display 110 may or may not always display the image projected by scanning laser projector 130. For example, an accessory product may always display the projected image, whereas a mobile phone embodiment may project one image while displaying different content on display 110, including displaying nothing at all.

Controls and connectors 120 may include any type of device without departing from the scope of the present invention. For example, controls and connectors 120 may include audio and/or video connectors, memory card slots, volume controls, menu buttons, or any other type of control or connector.

FIG. 2 shows a partial side view of the mobile device of FIG. 1. Retractable optic 140 is shown stowed on the first major face 102. Scanning laser projector 130 is shown projecting a major light ray 202. Major light ray 202 represents a fixed point within the raster pattern projected by scanning laser projector 130. In some embodiments, major light ray 202 corresponds to the bottom of the projected image, and in other embodiments, major light ray 202 corresponds to the center of the projected image.

Major light ray 202 has a fixed angular relationship to both major faces. As shown in FIG. 2, major light ray 202 has an angle θ1 relative to second major face 104. The angle θ1 is shown as 180 degrees, but this is not a limitation of the present invention.

FIG. 3 shows the mobile device of FIG. 1 projecting an image with the optic retracted so that it is not redirecting the image projected by scanning laser projector 130. Mobile device 100 is shown projecting an image onto projection surface 300. In some embodiments, projection surface 300 is normal to the emission direction of the projector. The projected image may have any aspect ratio, and may be in either a portrait or landscape mode. For example, in some embodiments the aspect ratio is 16:9 and the display is in a landscape mode. Also for example, in some embodiments, the display is in a portrait mode, and the aspect ratio is something other than 16:9.

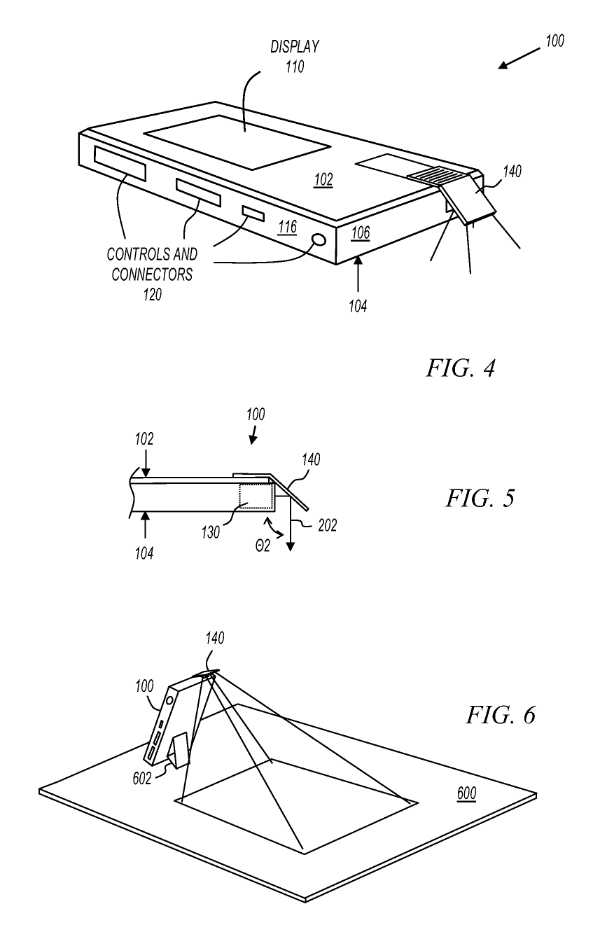

FIG. 4 shows a mobile device with a scanning laser projector and retractable optic in a deployed position in accordance with various embodiments of the present invention. In example embodiments represented by FIG. 4, retractable optic 140 is slidingly coupled to first major face 102 of the mobile device. Retractable optic 140, while staying coupled to first major face 102, is slid from its retracted position shown in FIG. 1 to its deployed position shown in FIG. 4. Although FIG. 4 shows retractable optic 140 being slid to deploy, this is not a limitation of the present invention. For example, retractable optic 140 may rotate when being deployed (rotatably coupled). Retractable optic 140 may use any mechanism to transition from being retracted to being deployed without departing from the scope of the present invention.

In some embodiments, retractable optic 140 includes a spring loaded hinged portion to allow the reflective portion to deploy in the fixed field of view when slid out over the projector port. In other embodiments, a track through which retractable optic slides includes a guide slot that guides retractable optic 140 to its angular resting place when deployed.

When deployed in the projector's fixed field of view, retractable optic 140 redirects the image projected by scanning laser projector as shown in FIG. 4. The angle through which the image is redirected is a function of the angle of retractable optic 140 when deployed. The example of FIG. 4 shows a redirection of substantially 90 degrees, but this is not a limitation of the present invention.

FIG. 5 shows a partial side view of the mobile device of FIG. 4. Mobile device 100 is shown with retractable optic 140 deployed into the fixed field of view of the scanning laser projector 130. Major light ray 202 is shown being redirected which results in major light ray 202 having an angle θ2 relative to second major face 104. The difference between angles θ1 and θ2 represents the angle through which the image is redirected when retractable optic 140 is deployed in the fixed field of view of scanning laser projector 130. In the examples of FIGS. 2 and 5, the difference between angles θ1 and θ2 is substantially 90 degrees, although this is not a limitation of the present invention. For example, in some embodiments, the difference between angles θ1 and θ2 is less than 90 degrees, and in other embodiments, the difference between angles θ1 and θ2 is greater than 90 degrees.

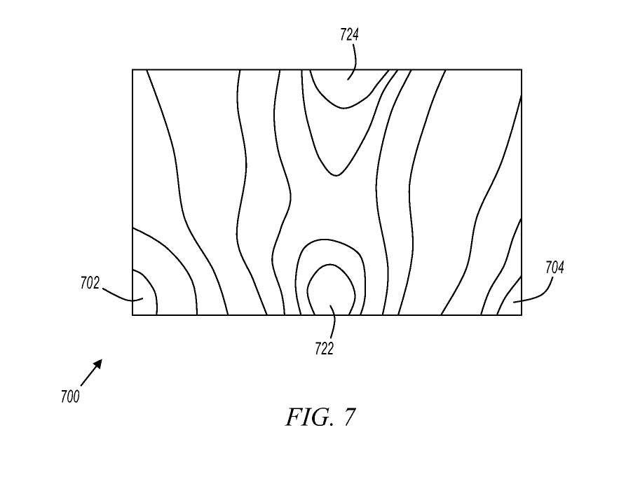

FIG. 6 shows the mobile device of FIG. 4 projecting an image with the optic deployed. Mobile device 100 is standing on one end at an angle relative to surface 600, and retractable optic 140 is deployed to redirect an image to display on surface 600. In the example of FIG. 6, mobile device 100 also includes a deployed kickstand 602 which determines the angle of mobile device 100 relative to surface 600.

Depending on a user's perspective, the displayed image may appear flipped due to the reflection from optic 140. In some embodiments, the image flipping may be corrected via hardware or software or a combination thereof. For example, scanning laser projector 130 may modify frame buffer contents to compensate for image flipping when retractable optic 140 is deployed.

The combination of mobile device 100 with scanning laser projector 130 and deployed retractable optic 140 form an ultra-short throw projector. Mobile device 100 is standing on a surface 600 which also serves as the projection surface. In the use case shown in FIG. 6, significant image distortion (e.g., keystone, smile, anamorphic) will result if retractable optic 140 is flat. In some embodiments, retractable optic 140 has a non-flat reflective surface to reduce distortion. Non-flat reflective surface embodiments are discussed further below with reference to FIG. 7.

FIG. 7 shows a surface map of a free-form optic in accordance with various embodiments of the present invention. Surface map 700 shows relative heights of different portions of the reflective surface of retractable optic 140. The bottom of surface map 700 represents the portion of retractable optic 140 that is closest to the projector port when deployed, and the top of surface map 700 represents the portion of retractable optic 140 that is furthest from the projector port when deployed.

In some embodiments, portions 702 and 704 are the areas with the highest surface height, and portions 722 and 724 are the areas with the lowest surface height. For example, if a reference plane is located somewhere between the highest and lowest points on surface map 700, then points 702 and 704 would be above this plane, and points 722 and 724 would be below this plane. The actual surface heights and contour shapes are a function of many variables including the angle of the mobile device relative to the surface, the angle of the retractable optic when deployed, and the elevation of the projector from the surface 600. In some embodiments, the height differences between 702, 704 and 722, 724 are on the order of four millimeters.

In some embodiments, retractable optic 140 includes a surface profile similar to that shown in FIG. 7 to substantially correct for keystone, smile, and anamorphic distortion. The term “substantially correct” means a correction that is sufficient to render keystone, smile, and anamorphic distortion unnoticeable to an ordinary viewer. A retractable optic with a surface profile in accordance with surface map 700 employs an optical surface that is neither radially nor rotationally symmetric.

The term “free-form” is used herein to describe a reflective surface having a contour defined by a polynomial that is a function of two independent, transverse coordinate variables. Said differently, the contour of surface map 700 can be expressed as a function of two Cartesian variables, but is not capable of being expressed as a function of a single radial variable. Accordingly, free-form surfaces will have neither rotational nor radial symmetry. By contrast, a typical lens is spherical or aspherical, and is therefore rotationally symmetric. In some embodiments of the present invention, retractable optic 140 employs free-form surfaces described by two transverse variables in a polynomial. The degree of the polynomial further defines the free-form surface. Embodiments described herein may employ polynomials of any degree required to substantially correct the keystone, smile, and anamorphic distortion.

Mathematically, the free-form optic is referred to as an extended polynomial surface having a surface height z of:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

where N is the number of polynomial coefficients in the series, and Aᵢ is the coefficient on the i^{th} extended polynomial term. The polynomials are a power series in x and y. The first term is x, then y, then x*x, x*y, y*y, etc. There are two terms of order 1, three terms of order 2, four terms of order 3, etc.

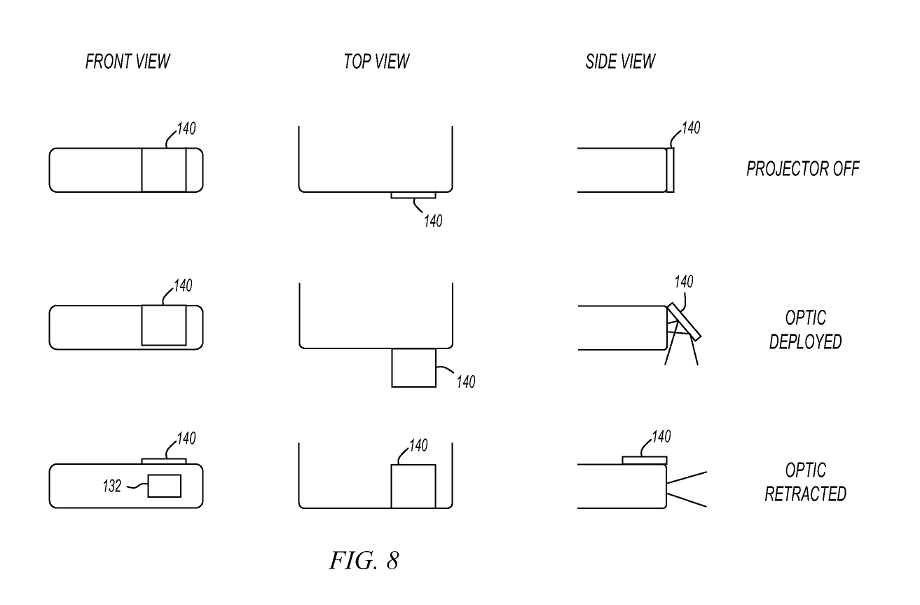

FIG. 8 shows front, top, and side views of a mobile device with a retractable optic in various positions in accordance with various embodiments of the present invention. As shown in FIG. 8, in some embodiments, a retractable optic may come to rest over the projector port when neither deployed nor retracted. In the top row of FIG. 8, retractable optic 140 is covering the projector port 132 when the projector is off. In the middle row of FIG. 8, retractable optic 140 is deployed in the fixed field of view of the projector to redirect the projected image. In the bottom row of FIG. 8, retractable optic 140 is retracted so the image is not redirected.

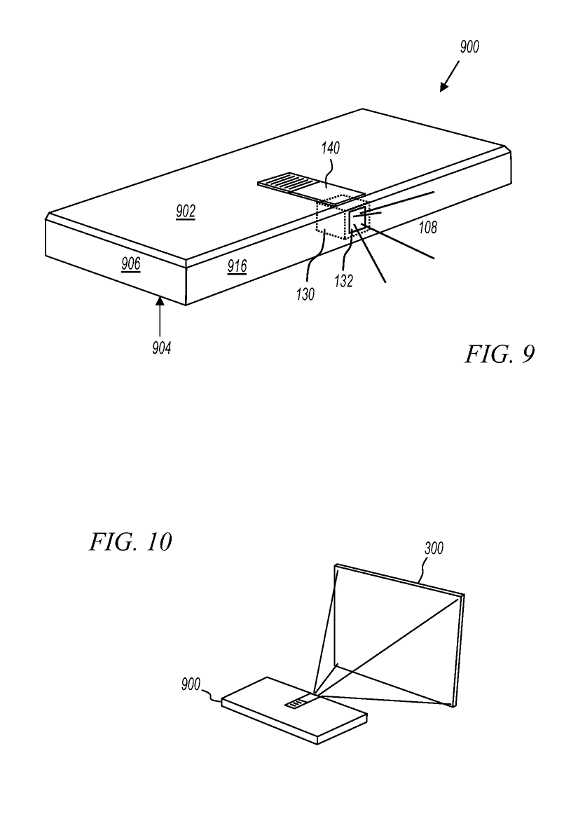

FIG. 9 shows a mobile device with a scanning laser projector and retractable optic in a retracted position in accordance with various embodiments of the present invention. Mobile device 900 includes a housing having opposing first and second major faces 902, 904, and first and second sides 906, 916 connecting the first and second major faces. Major face 902 is referred to as the first major face, and major face 904 is referred to as the second major face, although this is not a limitation of the present invention. The terms “first” and “second” are used only as labels, and are not meant to be used in a limiting sense. For example, major face 904 may be referred to as the first major face and major face 902 may be referred to as the second major face without departing from the scope of the present invention.

As shown in FIG. 9, the first and second major faces are substantially parallel, although this is not a limitation of the present invention. Further, sides 906 and 916 is shown at a substantially 90 degree angle relative to the first and second major faces. This is also not a limitation of the present invention. Sides 906 and 916 may be at any angle relative to one major face or the other without departing from the scope of the present invention.

Side 906 is referred to herein as a “short side” and side 916 is referred to herein as a “long side.” The terms “short side” and “long side” are used as labels to differentiate between sides of mobile device 900 based on their length. In embodiments represented by FIG. 9, projector port 132 is on a long side 916. This is in contrast to embodiments represented by FIG. 1, in which projector port 132 is on a short side 106.

Retractable optic 140 is movably coupled to the housing such that when retracted, the retractable optic 140 is stowed on one of the first and second major faces. In the example of FIG. 9, retractable optic 140 is stowed in a retracted position on the first major face 902. When retractable optic 140 is retracted, the image produced by projector 130 is projected into the fixed field of view 108 without being redirected by optic 140. Retractable optic 140 may be deployed such that it redirects the image. Examples of deployed retractable optics are described further below. In some embodiments, retractable optic 140 is a reflective optical device with a non-flat surface. Retractable optics with non-flat reflective surfaces are described above with reference to FIG. 7.

Mobile device 900 may be a hand held projection device with or without communications ability. For example, in some embodiments, mobile device 900 may be a handheld accessory projection apparatus with little or no other capabilities. Also for example, in some embodiments, mobile device 900 may be a device usable for communications, including for example, a cellular phone, a smart phone, a personal digital assistant (PDA), a global positioning system (GPS) receiver, or the like. Further, mobile device 900 may be connected to a larger network via a wireless (e.g., WiMax) or cellular connection, or this device can accept and/or transmit data messages or video content via an unregulated spectrum (e.g., WiFi) connection.

Mobile device 900 may also be a hand held interactive projection device. For example, in some embodiments, a user may interact with projected content by gesturing within the fixed field of view 108. Interactive embodiments are described further below.

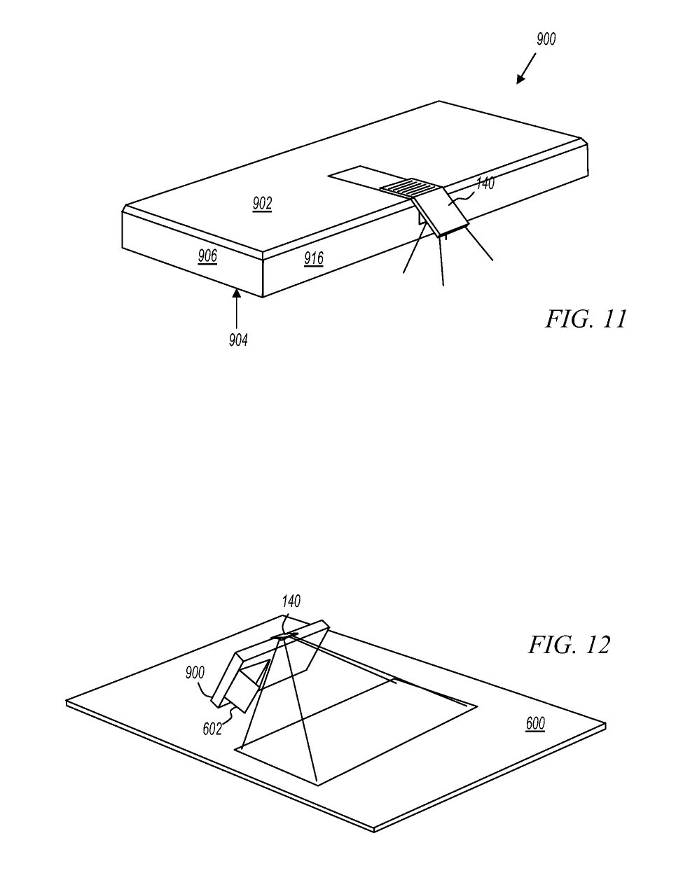

FIG. 10 shows the mobile device of FIG. 9 projecting an image with the optic retracted so that it is not redirecting the image projected by scanning laser projector 130. Mobile device 900 is shown projecting an image onto projection surface 300. In some embodiments, projection surface 300 is normal to the emission direction of the projector. The projected image may have any aspect ratio, and may be in either a portrait or landscape mode. For example, in some embodiments the aspect ratio is 16:9 and the display is in a landscape mode. Also for example, in some embodiments, the display is in a portrait mode, and the aspect ratio is something other than 16:9.

FIG. 11 shows a mobile device with a scanning laser projector and retractable optic in a deployed position in accordance with various embodiments of the present invention. In example embodiments represented by FIG. 11, retractable optic 140 is slidingly coupled to first major face 902 of the mobile device. Retractable optic 140, while staying coupled to first major face 902, is slid from its retracted position shown in FIG. 9 to its deployed position shown in FIG. 11. Although FIG. 11 shows retractable optic 140 being slid to deploy, this is not a limitation of the present invention. For example, retractable optic 140 may rotate when being deployed (rotatably coupled). Retractable optic 140 may use any mechanism to transition from being retracted to being deployed without departing from the scope of the present invention.

In some embodiments, retractable optic 140 includes a spring loaded hinged portion to allow the reflective portion to deploy in the fixed field of view when slid out over the projector port. In other embodiments, a track through which retractable optic slides includes a guide slot that guides retractable optic 140 to its angular resting place when deployed.

When deployed in the projector's fixed field of view, retractable optic 140 redirects the image projected by scanning laser projector as shown in FIG. 11. The angle through which the image is redirected is a function of the angle of retractable optic 140 when deployed. The example of FIG. 11 shows a redirection of substantially 90 degrees, but this is not a limitation of the present invention.

FIG. 12 shows the mobile device of FIG. 9 projecting an image with the optic deployed. Mobile device 900 is standing on one long side at an angle relative to surface 600, and retractable optic 140 is deployed to redirect an image to display on surface 600. In the example of FIG. 12, mobile device 900 also includes a deployed kickstand 602 which determines the angle of mobile device 900 relative to surface 600.

Depending on a user's perspective, the displayed image may appear flipped due to the reflection from optic 140. In some embodiments, the image flipping may be corrected via hardware or software or a combination thereof. For example, scanning laser projector 130 may modify frame buffer contents to compensate for image flipping when retractable optic 140 is deployed.

The combination of mobile device 900 with scanning laser projector 130 and deployed retractable optic 140 form an ultra-short throw projector. Mobile device 900 is standing on a surface 600 which also serves as the projection surface. In the use case shown in FIG. 11, significant image distortion (e.g., keystone, smile, anamorphic) will result if retractable optic 140 is flat. In some embodiments, retractable optic 140 has a non-flat reflective surface to reduce distortion. Non-flat reflective surface embodiments are discussed above with reference to FIG. 7.

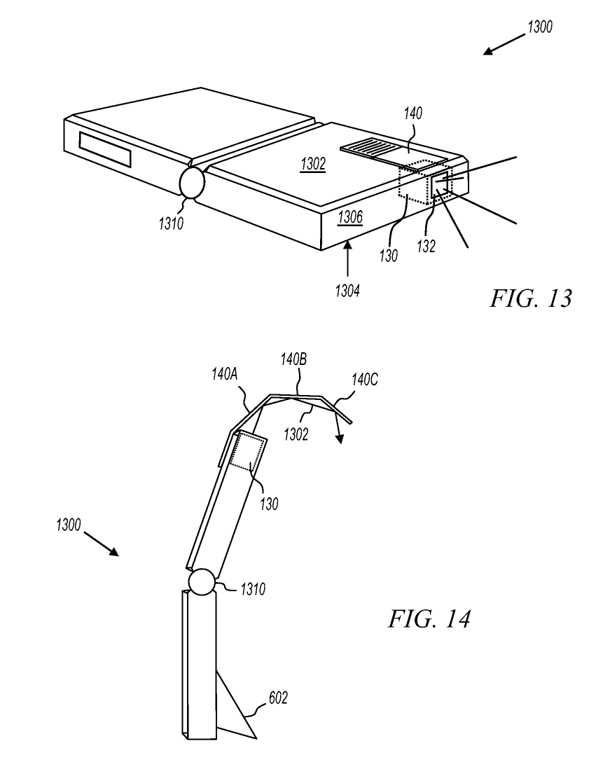

FIG. 13 shows a mobile device with a scanning laser projector, a retractable optic, and an articulating joint in accordance with various embodiments of the present invention. Mobile device 1300 includes a housing with major faces 1302 and 1304. Scanning laser projector 130 projects content from projector port 132 on short side 1306.

Mobile device 1300 is similar to mobile devices 100 (FIG. 1) and 900 (FIG. 9) with the exception of articulating joint 1310. Articulating joint 1310 allows two parts of the housing to have an angle relative to each other as shown in FIG. 14.

In embodiments represented by FIG. 13, retractable optic 140 may include multiple reflective surfaces. For example, retractable optic 140 may include one, two, three, or more reflective surfaces. One embodiment with three reflective surfaces is shown in FIG. 14.

FIG. 14 shows a side view of the mobile device of FIG. 13 with the optic deployed. Retractable optic 140 is shown deployed with three reflective surfaces 140A, 140B, 140C. Major light ray 1302 is reflected off each of the reflective surfaces. As shown in FIG. 14, articulating joint 1310 along with multiple reflective surfaces of retractable optic 140 allow an infinite number of angles for major light ray 1302 when the image is redirected.

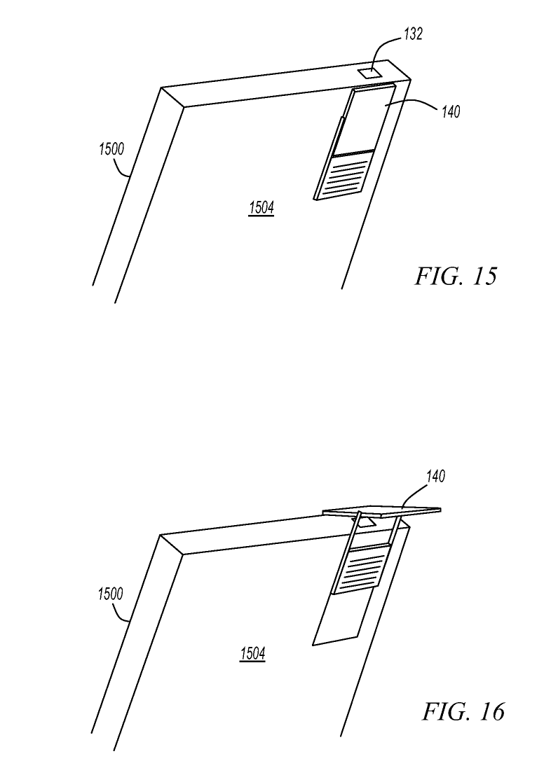

FIG. 15 shows a mobile device with a retractable optic in a retracted position in accordance with various embodiments of the present invention. Mobile device 1500 includes retractable optic 140 stowed on major face 1504. Mobile device 1500 differs from mobile device 100 (FIGS. 1, 4) in that mobile device 100 redirects the image away from the major face upon which retractable optic 140 is coupled, whereas mobile device 1500 redirects the image towards the major face upon which retractable optic 140 is coupled. In some embodiments, mobile devices 100 and 1500 may be referred to as having a retractable optic on opposite major faces. In other embodiments, one of mobile device 100 and 1500 may be referred as having a retractable optic movably coupled to a first major face, and the other mobile device may be referred to as having a retractable optic movably coupled to a second major face.

FIG. 16 shows the mobile device of FIG. 15 with the retractable optic in a deployed position in accordance with various embodiments of the present invention. When deployed on mobile device 1500, retractable optic 140 redirects the image toward major face 1504, which is the major face upon which retractable optic 140 is movably coupled. In some embodiments, retractable optic 140 is spring loaded such that when it is slid out over projector port 132, it rotates into place as shown in FIG. 16. Mobile device 1500 may include a kickstand such as kickstand 602 (FIG. 6) so that mobile device 1500 may be used as an ultra-short throw projector as shown in FIG. 6.

In some embodiments, kickstand 602 is mechanically coupled to retractable optic 140. In these embodiments, kickstand 602 and retractable optic 140 are deployed with a fixed relationship, allowing preset positions to be deployed.

Thus far, mobile devices have been shown and described with projector ports on the sides of the device. For example, projector port 132 is shown on the short side 106 in FIG. 1, and on the long side 916 in FIG. 9. In some embodiments, mobile devices include projector ports on a major face of the device such as major face 104 (FIG. 1), or major face 904 (FIG. 9). In these embodiments the retractable optic is also coupled to the mobile device in such a manner that when deployed it can redirect an image that emanates from the major face.

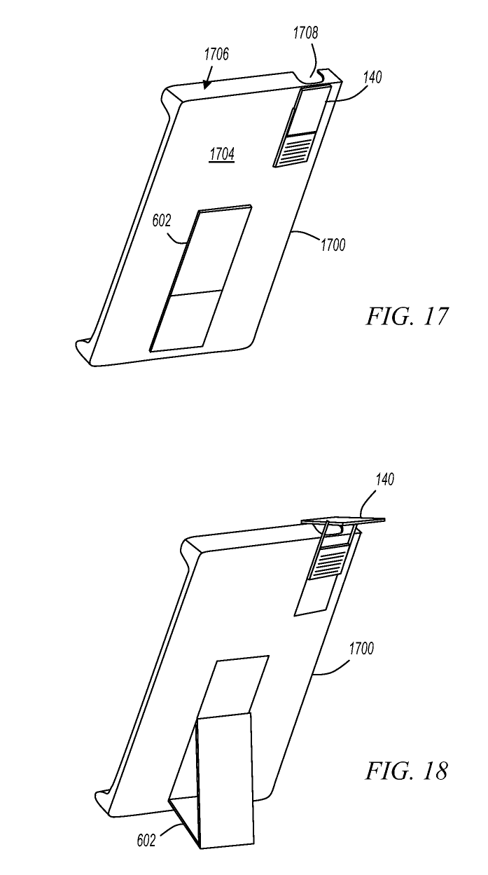

FIG. 17 shows a mobile device case with a retractable kickstand and a retractable optic in retracted positions in accordance with various embodiments of the present invention. Mobile device case 1700 includes major face 1704 and minor face 1706. Retractable optic 140 and kickstand 602 are movably coupled to major face 1704. Retractable optic 140 is shown with a mechanism similar to that shown in FIG. 15. Kickstand 602 and retractable optic 140 are shown retracted in FIG. 17.

Mobile device case 1700 also includes a recessed portion opposing major face 1704. The recessed portion is shaped to accept a major face of a mobile device with a scanning laser projector. Mobile device case 1700 may receive any type of mobile device including a mobile phone, a standalone accessory projector, or the like.

Minor face 1706 includes aperture 1706. Aperture 1706 is placed to allow a projector within a mobile device to project an image therethrough. Aperture 1706 is shown at one end of a minor face of the mobile device case, although this is not a limitation of the present invention. The aperture may be at any point on mobile device case 1700 to align with a projector port on a mobile device. The aperture may be on any major face or any minor face.

FIG. 18 shows the mobile device case of FIG. 17 with the kickstand and retractable optic in deployed positions in accordance with various embodiments of the present invention. Mobile device case 1700 deploys retractable optic 140 in a manner similar to that shown on mobile device 1500 (FIG. 16). When mobile device case 1700 receives a mobile device with a scanning laser projector, an ultra-short throw projector may result when retractable optic 140 is deployed.

Kickstand 602 is also shown in a deployed position. Kickstand 602 may deploy to allow mobile device case 1700 to stand at a predetermined angle to the surface upon which it stands. For example, kickstand 602 may cause mobile device case 1700 to stand at an angle of substantially 60 degrees.

In some embodiments, mobile device case 1700 includes an optic that always redirects the image. For example, the optic may not be retractable, but instead may be fixed in a position similar to the deployed position shown in FIG. 18. In still further embodiments, mobile device case 1700 may be a dock that accepts a mobile device and converts the projector from a short throw projector to an ultra short throw projector.

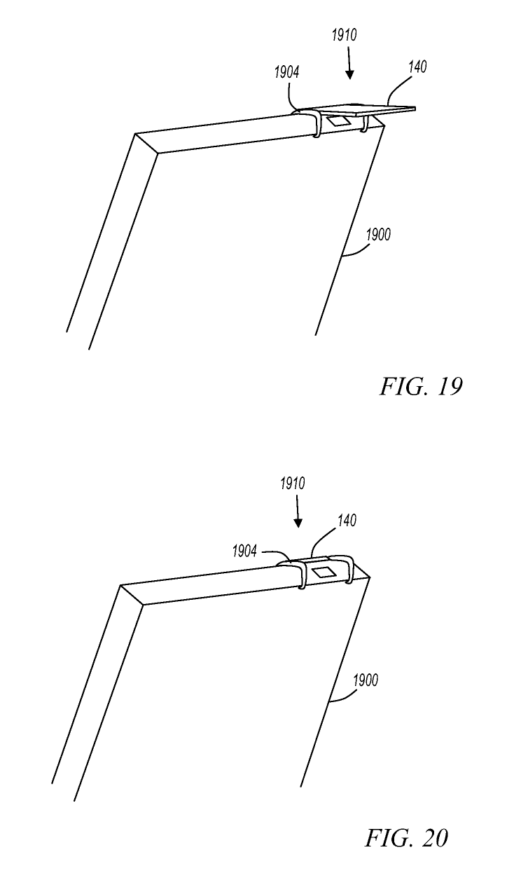

FIG. 19 shows a mobile device with a retractable optic attachment in a deployed position in accordance with various embodiments of the present invention. Retractable optic attachment 1910 includes retractable optic 140 and fastening mechanism 1904 to fasten the attachment over a projection port of mobile device 1900. In some embodiments, fastening mechanism 1904 includes clips that clip to mobile device 1900. When deployed as in FIG. 19, retractable optic 140 redirects an image that emanates from the projection port. In some embodiments, retractable optic 140 is a free-form optic that includes a shape to correct for distortion resulting from redirecting the image.

FIG. 20 shows a mobile device with a retractable optic attachment in a retracted position in accordance with various embodiments of the present invention. FIG. 20 shows retractable optic 140 being retracted on the major face that is out of view in the figure. In some embodiments, retractable optic 140 is retracted onto the opposite major face as in FIGS. 15 and 17.

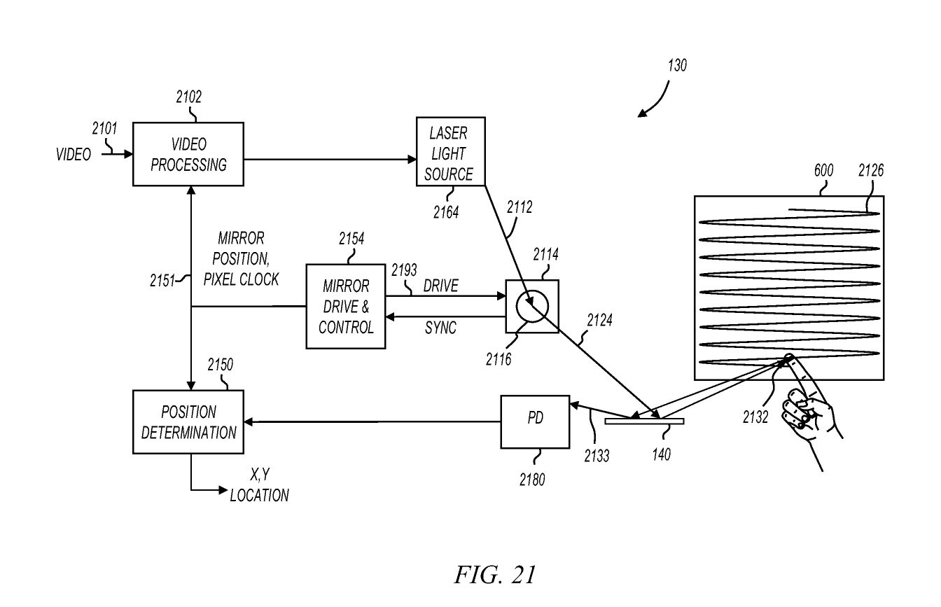

FIG. 21 shows a block diagram of a scanning laser projector in accordance with various embodiments of the present invention. As shown in FIG. 21, scanning laser projector 130 includes video processing component 2102, laser light source 2164, scanning platform 2114, and photodetector 2180.

In operation, video processing component 2102 receives video data on node 2101 and produces display pixel data representing luminance values of pixels that are to be displayed. The video data 2101 represents image source data that is typically received from a host device with pixel data on a rectilinear grid, but this is not essential. For example, video data 2101 may represent a grid of pixels at any resolution (e.g., 640×480, 848×480, 1280×720, 1920×1080). The raster pattern produced by projection scanning laser projector 130 does not necessarily align with the rectilinear grid in the image source data, and video processing component 2102 operates to produce display pixel data that will be displayed at appropriate points on the raster pattern. For example, in some embodiments, video processing component 2102 interpolates vertically and/or horizontally between pixels in the source image data to determine display pixel values along the scan trajectory of the raster pattern.

Video processing component 2102 may include any circuitry capable of performing the functions described. For example, in some embodiments, video processing component 2102 includes digital circuits capable of performing interpolation such as multipliers, shifters, and adders. Also for example, in some embodiments, video processing component 2102 may include hardware circuits and may also include a processor that executes instructions.

Light source 2164 receives commanded luminance values from video processing component 2102 and produces light beam 2112 having grayscale values in response thereto. Light source 2164 may be monochrome or may include multiple different color light sources. For example, in some embodiments, light source 2164 includes red, green, and blue light sources. In these embodiments, video processing component 2102 outputs display pixel luminance values corresponding to each of the red, green, and blue light sources. Also for example, light produced by light source 2164 may be visible or nonvisible. For example, in some embodiments, one or more sources of light within light source 2164 may produce infrared (IR) light.

Light beam 2112 impinges on scanning platform 2114 which is part of a microelectromechanical system (MEMS) based scanner or the like. In some embodiments, additional optical elements are included in the light path between light source 2164 and scanning platform 2114. For example, scanning laser projector 130 may include collimating lenses, dichroic mirrors, or any other suitable optical elements. Light beam 2112 then reflects off scanning mirror 2116 to generate a controlled output beam 2124. A scanning mirror drive circuit 2154 provides one or more drive signal(s) to control the angular motion of scanning mirror 2116 to cause output beam 2124 to generate a raster scan 2126 of pixels on a projection surface 600. In operation, light source 2164 is modulated to produce light pulses, and scanning mirror 2116 reflects the light pulses to create display pixels as beam 2124 traverses raster pattern 2126.

Scanning mirror 2116 deflects on two axes in response to drive stimuli received on node 2193 from mirror drive and control circuits 2154. The shape of the raster pattern swept by scanning mirror 2116 is a function of the mirror movement on its two axes. For example, in some embodiments, scanning mirror 2116 sweeps in a first dimension (e.g., vertical dimension) in response to sawtooth wave stimulus, resulting in a substantially linear and unidirectional vertical sweep. Also for example, in some embodiments, scanning mirror 2116 sweeps in a second dimension (e.g., horizontal dimension) according to a sinusoidal stimulus, resulting in a substantially sinusoidal horizontal sweep.

Scanning platform 2114 is an example of a scanning mirror assembly that scans light in two dimensions. In some embodiments the scanning mirror assembly includes a single mirror that scans in two dimensions (e.g., on two axes). Alternatively, in some embodiments, scanning platform 2114 may be an assembly that includes two scan mirrors, one which deflects the beam along one axis, and another which deflects the beam along a second axis largely perpendicular to the first axis.

FIG. 21 also shows retractable optic 140 in a deployed position. Output beam 2124 reflects off optic 140 prior to sweeping raster pattern 2126 on projection surface 600.

Photodetector 2180 is shown receiving a reflection from a reflector 2132 within the field of view of the projection apparatus. The reflection is also reflected off optic 140 when in the deployed position. In the example of FIG. 21, the reflection is from a reflective object on a user's finger being used as a pointer. In some embodiments, a reflector may be integrated into a pointing device, or may be applied to any object with glue, tape, or any other means. The reflector may incorporate any type of reflective device or material that can reflect all or a portion of output beam 2124. For example, in some embodiments, reflector 2132 may be a corner reflector or a retroreflector. Also for example, in other embodiments, reflector 2132 may include reflective tape with diffusive qualities.

In some embodiments, reflector 2132 is part of a separate object. For example, in some embodiments, reflector 2132 may be on the end of a stylus used for pointing. Also for example, in some embodiments, reflector 132 may be active or passive. Passive embodiments have been described. Active embodiments may include a light source that emits light when controlled output beam 2124 passes over reflector 2132. In other active embodiments, reflector 2132 may include a radio frequency (RF) source to emit an RF signal when controlled output beam 2124 passes over reflector 2132.

When controlled output beam 2124 passes over reflector 2132, light is reflected as shown at 2133. The reflected light is sensed by photodetector (PD) 2180. As described more fully below, the timing of the reflected light can be compared to the timing of the raster scan 2126 to determine the location of the reflector 2132 relative to the image painted by raster scan 2126. For example, when a particular pixel is reflected by reflector 2132, determining the location of that pixel within the raster scan 2126 also determines the location of the reflector within the raster scan 2126.

In some embodiments, light source 2164 sources nonvisible light such as infrared light. In these embodiments, PD 2180 is able to detect the same wavelength of nonvisible light. For example, in some embodiments, light source 2164 may be an infrared laser diode that produces light with a wavelength of substantially 808 nanometers (nm). The wavelength of light is not a limitation of the present invention. Any wavelength, visible or nonvisible, may be used without departing from the scope of the present invention.

In some embodiments, mirror drive and control circuit 2154 has knowledge of the position of scanning mirror 2116, from which the position of a reflection may be derived. For example, mirror drive and control circuits 2154 may receive one or more sync signals from scanning platform 2114 describing horizontal and vertical mirror positional information. Mirror drive and control circuits 2154 may output the mirror position information at 2151. Mirror drive and control circuits 2154 may also generate and distribute a pixel clock at 2151. Various other circuits receive the mirror position information and pixel clock. For example, video processing component 2102 may utilize the mirror position information and pixel clock to determine what image pixel information is to be used to generate display pixel information and when. Also for example, position determination component 2150 may utilize the mirror position information to determine the x,y location of a reflector within the projector's field of view.

Position determination component 2150 may be any type of circuit that can receive an indication of reflected light and determine an x,y location of the reflector within the display field. In some embodiments, position determination component 2150 includes a processor and a memory to hold instructions that are executed by the processor. In other embodiments, position determination component 2150 includes one or more application specific integrated circuits.

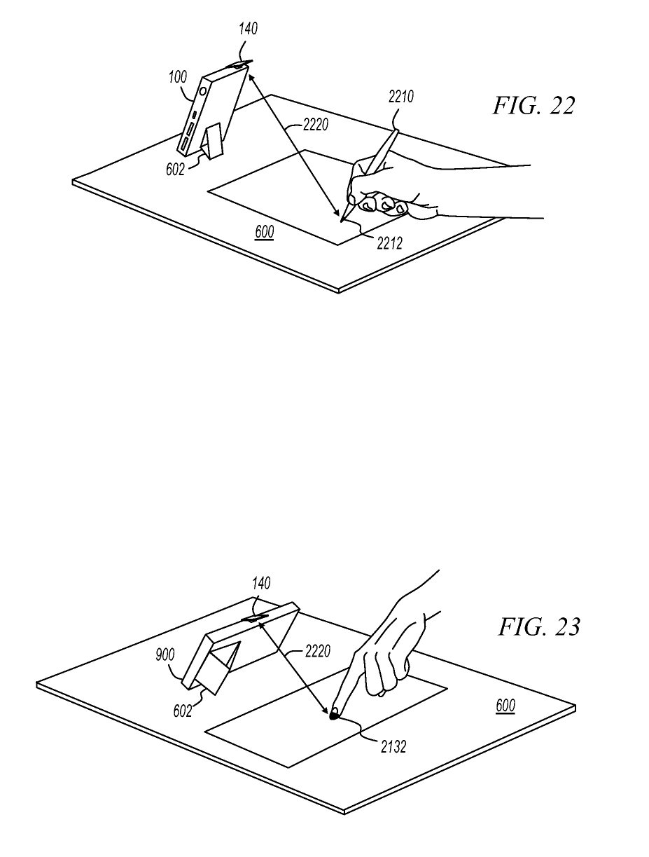

FIGS. 22 and 23 show users interacting with a scanning laser projector in a mobile device. FIG. 22 shows mobile device 100 with deployed retractable optic 140 and kickstand 602. The scanning laser projector is projecting an image on projection surface 600 as described above with reference to FIG. 21. A user interacts with projected content using stylus 2210 with reflector 2212. Arrow 2220 represents the output beam as it passes over reflector 2212 as well as the reflected light that is used by scanning laser projector 130 (FIG. 21) to determine the x,y location of stylus 2212.

FIG. 23 shows a user interacting with content projected by mobile device 900. Arrow 2220 represents the output beam as it passes over reflector 2132 as well as the reflected light that is used by scanning laser projector 130 (FIG. 21) to determine the x,y location of reflector 2132.

In some embodiments, optic 140 includes a “side flange” that is used to direct the reflection to the photodetector. For example, a side flange may include a flat surface or a free form surface that is simpler than are of optic 140 used to reflect the image.

Any of the mobile device embodiments may include interactive projection capabilities as shown in FIGS. 21-23. For example, mobile device 1300 (FIG. 13) and mobile device 1500 (FIG. 15) may include interactive projection capabilities.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims

What is claimed is:

1. A mobile device comprising:
a housing having opposing first and second major faces, and a side connecting the first and second major faces;
a scanning laser projector to project an image from the side into a fixed field of view at a first angle relative to the first major face; and
a retractable optic that is either retracted out of the fixed field of view or deployed in the fixed field of view to redirect the image at a second angle relative to the first major face.

2. The mobile device of claim 1 wherein the second angle is smaller than the first angle.

3. The mobile device of claim 1 wherein a difference between the first and second angles is substantially 90 degrees.

4. The mobile device of claim 1 wherein a difference between the first and second angles is greater than 90 degrees.

5. The mobile device of claim 1 wherein the first and second major faces are substantially parallel.

6. The mobile device of claim 1 wherein the retractable optic is movably coupled to the housing such that when retracted, the retractable optic is stowed on one of the first and second major faces.

7. The mobile device of claim 6 wherein the retractable optic is stowed on the first major face.

8. The mobile device of claim 6 wherein the retractable optic is stowed on the second major face.

9. The mobile device of claim 1 wherein the retractable optic comprises a free-form optic.

10. The mobile device of claim 1 wherein the retractable optic is slidingly coupled to the first major face.

11. The mobile device of claim 1 further comprising a kickstand to be deployed when the retractable optic is deployed.

12. A case to receive a mobile device, comprising:
a major face and an opposing recessed portion to receive a first major face of the mobile device;
a minor face having an aperture to allow a projector within the mobile device to project an image therethrough; and
a retractable optic to conditionally redirect the image.

13. The case of claim 12 wherein the retractable optic comprises a free form optic.

14. The case of claim 13 wherein the free form optic includes a shape to correct for distortion resulting from redirecting the image.

15. The case of claim 12 wherein the retractable optic is slidingly coupled to the major face.

16. The case of claim 12 further comprising a retractable kickstand coupled to the major face.

17. An apparatus comprising:
a fastening mechanism to fasten the apparatus over a projection port of a mobile device; and
a free-form optic oriented to redirect an image from the projection port.

18. The apparatus of claim 17 wherein the fastening mechanism comprises at least one clip.

19. The apparatus of claim 17 wherein the free-form optic includes a shape to correct for distortion resulting from redirecting the image.

20. The apparatus of claim 17 wherein the free-form optic is retractable such that the image is not redirected when the free-form optic is retracted.
